(19) United States
(12) Patent Application Publication
(10) Pub. No.: US 2002/0087494 A1
(43) Pub. Date: Jul. 4, 2002

(54) Postage meter with digital print head

(76) Inventor: Raymond John Herbert, Leigh-on-Sea (GB)

Correspondence Address: SHOEMAKER AND MATTARE, LTD., 2001 Jefferson Davis Highway, Suite 1203, Crystal Plaza Building 1, Arlington, VA, 22202, US

(21) Appl. No.: 09/990,386

(22) Filed: Nov. 23, 2001

Related U.S. Application Data
(63) Continuation of application No. 09/237,813, filed on Jan. 27, 1999, now abandoned.

(30) Foreign Application Priority Data
Jan. 28, 1998 (GB) 9801744.5

(51) Int. Cl. G06F 17/00

(52) U.S. Cl. 705/408

(57) ABSTRACT

A postage meter is provided with an authorized digital print head, for example an ink jet print head, for printing postage indicia on mail items. The print head is operated by print data signals output by a microprocessor controlling operation of the postage meter. In order to prevent fraudulent printing of postage indicia by connecting an additional print head to be operated by the print data signals, the print data signals define an indicium containing an indication that the indicium is invalid. The authorized print head is provided with control circuitry that is operative to prevent operation of the authorized print head by those print data signals representing the indication of invalidity so that the authorized print head only prints a valid indicium whereas an unauthorized print head without the control circuitry prints indicia containing the indication of invalidity.

### BACKGROUND OF THE INVENTION

This invention relates to postage meters in which accounting functions are effected in a meter module and a print head in a printer module is controlled by the meter module to print postage indicia on mail items.

Currently available postage meters use digital printers for printing postage indicia, the digital printers being thermal printers in which thermal print elements are selectively energized to transfer ink from an ink layer on a ribbon to the surface of the mail item to create a postage indicium on the mail item. In such printers the ink ribbon is replaced at intervals when the ink layer has been exhausted but the print head per se remains operational for a long period and may require to be replace relatively infrequently. Accordingly the print head can be incorporated into the postage meter in a secure manner so that it is difficult or impossible for fraudulent attempts to be made in which unauthorized postage indicia are printed. If it becomes necessary to replace the print head, the secure incorporation of the print head into the meter necessitates invasion of the security and hence replacement of the print head must be carried out by authorized service personnel in an authorized manner.

It is now proposed to utilize ink jet print heads in postage meters for printing postage indicia. Commonly available standard ink jet print heads are manufactured in replaceable cartridge form in which the cartridge contains an ink supply for the print head. When the ink supply becomes depleted it is necessary to replace the entire print head cartridge. Since the print head must be replaced relatively frequently due to depletion of the ink supply it would be inconvenient to require replacement of the print head to be carried out in a secure manner by authorized service personnel. It is desirable to be able to use standard manufactured ink jet print heads and to permit replacement thereof to be carried out without any necessity of breaching security so that the print head can be replaced by users of the postage meter.

### SUMMARY OF THE INVENTION

According to a first aspect of the invention a postage meter includes first control means to generate print signals defining an invalid postage indicium, said print signals including first print data signals defining a valid postage indicium and second print data signals defining a void marking; authorized printing means operative in response to said print data signals to print a postage indicium on a mail item; and second control means operative to prevent operation of the authorized printing means by said second print data signals whereby the authorized printing means is operated by the first print data signals to print a valid postage indicium.

According to a second aspect of the invention a method of printing postage indicia includes the steps of generating print data signals defining an invalid postage indicium; outputting said print data signals to authorised printing means; and rejecting selected ones of said print data signals to cause the authorised printing means to print a valid postage indicium.

### BRIEF DESCRIPTION OF THE DRAWING

An embodiment of the invention will now be described with reference to the drawings in which

FIG. 1 is a block circuit diagram of a postage meter module and a printer module connected to the postage meter module,

FIG. 2 illustrates a postage indicium invalidly printed on a mail item, and

FIG. 3 illustrates a postage indicium validly printed on a mail item.

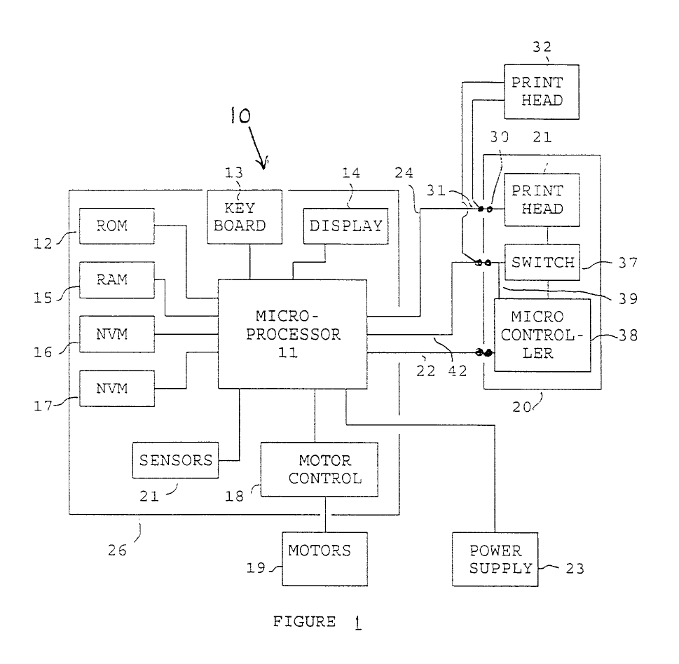

### DESCRIPTION OF THE PREFERRED EMBODIMENT

Referring to the drawing, a postage meter module 10 includes electronic accounting and control means comprising a micro-processor 11 operating under program routines stored in a read only memory (ROM) 12. A keyboard 13 is provided for input of commands and data by a user and a display 14 is provided to enable display of information to the user. A random access memory (RAM) 15 is provided for use as a working store for storage of temporary data during operation of the postage meter. Non-volatile duplicated memories 16, 17 are provided for the storage of critical data relating to use of the postage meter and which is required to be retained even when the postage meter is not powered. The microprocessor 11 carries out accounting functions in relation to use of the postage meter for franking mail items with postage charges applicable to handling of the mail items by the postal authority or another carrier. Accounting data relating to use of the postage meter for printing franking impressions representing postage charges for mail items and any other critical data to be retained is stored in the non-volatile memories 16, 17. The accounting data includes a value of credit available for use by the meter in franking mail items, an accumulated total of value used by the meter in franking mail items, a count of the number of mail items franked by the meter and a count of the number of mail items franked with a postage charge in excess of a predetermined value. The value of credit is stored in a descending credit register, the accumulated total value is stored in an ascending tote register, the count of items is stored in an items register and the count of items franked with a postage charge in excess of a predetermined value is stored in a large items register. As is well known in the postage meter art, each of the registers referred to hereinbefore for storing accounting data is replicated in order to enable integrity of the accounting data to be maintained even in the event of a fault or termination of power to the meter during a franking operation. Two replications of each of the registers are provided in each of the memory devices 16, 17.

A motor controller 18 is controlled by the microprocessor 11 to control operation of motors 19 driving feeding means (not shown) for producing relative motion between a print head module 20 and mail item. The digital print head module 20 may be stationary and the mail items fed past the print head or the mail item may be stationary and the print head module 20 is moved along a path so that the print head scans a print field area of the mail item that is to receive an ink image. Sensors 21 are provided to sense and monitor the relative motion. The sensors provide signals to the microprocessor 11 to enable the microprocessor to selectively energize printing elements of a print head 21 in the print head module 20 at appropriate times. During the relative motion between the print head and the mail item during a printing operation, the microprocessor 11 outputs on line 22, in each of a series of printing cycles, print data signals selecting those ones of the printing elements of the print head 21 which are to be energized in each respective printing cycle. A pulse of electrical power is supplied to the selected printing elements from a power source 23 when a strobe signal is supplied by the microprocessor on a line 24 to the print head.

Preferably the print head is an ink jet print head in which ink is ejected from selected ones of a plurality of nozzles. Ejection of the ink from a nozzle may be effected by heating of a resistive element to create a bubble in the ink and thereby eject a droplet of ink from a nozzle. The nozzles are disposed in a line or lines extending transversely to the direction in which the mail item is fed. The nozzles may be disposed in two lines spaced apart and parallel to one another with the nozzles of one line disposed in alignment with spaces between nozzles in the other line. This arrangement of nozzles permits a print resolution to be attained which is higher than the minimum spacing at which the nozzles can be disposed. Because there is relative motion between the mail item and the print head during the printing operation, repeated selection and energization of selected resistive elements in the series of printing cycles results in deposition of dots of ink in required positions of a corresponding series of columns spaced along the mail item in the direction of the relative motion. Accordingly a complete printed impression is built up in a column by column manner in the series of printing cycles of a printing operation.

It will be appreciated that, as is well known in the postage meter art, the postage meter must operate in a secure manner and be protected from attempts to use the meter fraudulently for example by utilizing the postage meter to print franking impressions on mail items for which no corresponding postage charge has been accounted for by the accounting means. Accordingly those parts of the postage meter required to be secured against unauthorized tampering are housed in a secure housing 26.

In so-called prepayment operation of a postage meter, the descending register of the meter is set with a value of credit which is then available for use in franking mail items and, as each mail item is franked with a postage charges, the value in the descending register is decremented by the amount of the postage charge. Each time a franking operation is to be performed, the micro-processor carries out a routine in which a determination is made as to whether the value of credit in the descending register is sufficient to cover the cost of the postage charge intended to be applied in respect of the mail item. If the value in the descending register is sufficient the franking operation is continued and the values in the registers are updated to account for the postage charge and the franking impression is printed. However if the value of credit in the descending register is less than the postage charge intended to be applied to the mail item, the routine is terminated and the franking impression is not printed. Generally, if the microprocessor determines that the value of credit in the descending register is less than a predetermined value, the microprocessor terminates the current franking operation and locks the postage meter from further use in franking mail items until such time as the value of credit in the descending register has been reset to a higher value.

Ink jet print heads are commonly available off the shelf as a standard manufactured item. Accordingly it is convenient to use an off the shelf print head in a postage meter for printing the postage indicia on mail items. Commonly available off the shelf ink jet print heads are constructed as a removable cartridge with an ink supply contained in the cartridge. Accordingly when the ink supply becomes depleted the cartridge including the print head is removed and replaced with a replacement cartridge containing a print head and a full ink supply. Due to the need to replace the cartridge when the ink supply becomes depleted it is desirable that the replacement of the cartridge does not require a breach of the security of the meter so that the replacement can be effected by a user of the postage meter. It will be appreciated that the cartridge is provided with electrical contacts 30 which mate with corresponding contacts 31 connected to the meter module 10 to convey electrical signals between the print head and the meter 10. As a result there is unsecured access to these contacts when the print head cartridge is removed and replaced. Accordingly there is a possibility that access to these contacts could enable unauthorized tampering to occur. For example it might be possible for a second print head 32 to be connected in parallel with the print head 21 thereby enabling duplicate postage indicia to be printed.

The present invention is concerned with providing evidence that unauthorized printing of postage indicia as described hereinbefore has occurred and to invalidate any postage indicia printed fraudulently.

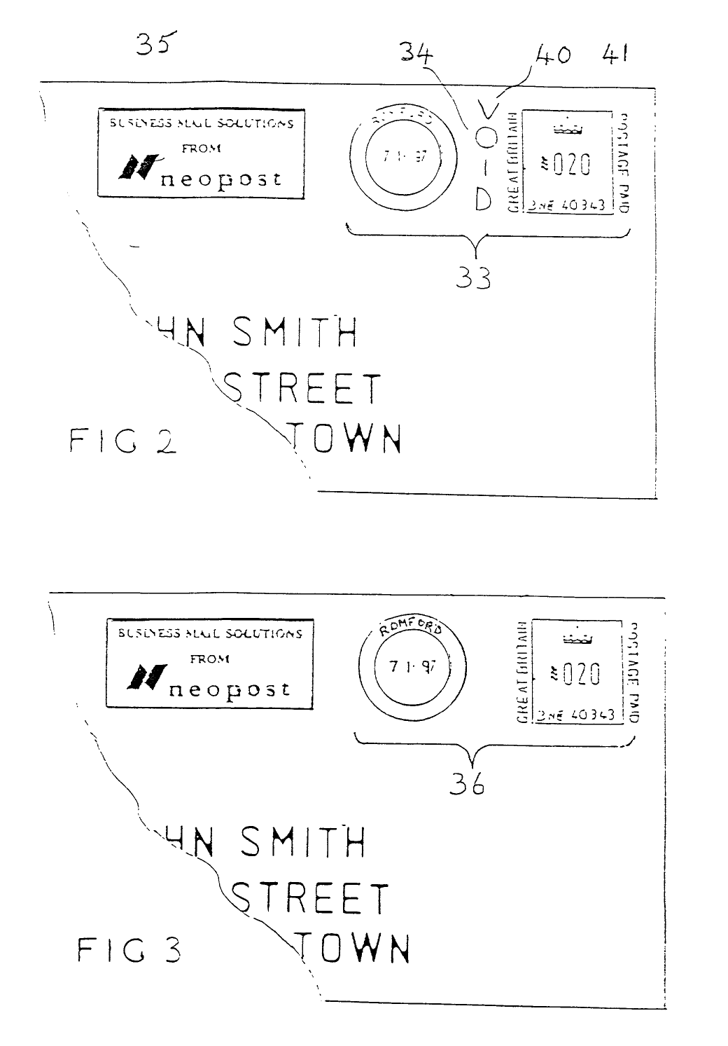

During a print operation to print a postage indicium, the microprocessor is programmed to send print data signals to the print head module defining a postage indicium 33 which contains information 34 indicative that the postage indicium printed on the mail item 35 is not valid as shown in FIG. 2. That is to say, in addition to sending print data signals which will cause the print head to print a required postage indicium 36 as shown in FIG. 3, the microprocessor 11 sends additional print data signals which would cause printing of data or a pattern 34 in an area or areas of the print field on the mail item. The area or areas may be unused in printing of a valid postage indicium. The additional print data signals may cause printing of a message, for example the word ‘VOID’ as shown in FIG. 2, or of a conspicuous pattern in the print field and thereby indicate that the printed indicium 33 is unauthorized.

It will be appreciated that when the signals sent by the microprocessor 11 to the electrical contacts 31 are sent on to the unauthorized print head 32, the print head will print a postage indicium 33 containing the void mark 34. Hence inspection of mail items 35 at a postal authority will reveal invalid postage indicia printed by the unauthorized print head 32.

The print head module 20 is a modified off the shelf print head cartridge and includes circuitry additional to that provided in off the shelf print heads 32. This additional circuitry includes means to ignore or reject the additional print data signals that cause printing of the invalid mark 34. The additional circuitry comprises a switch 37 controlling operation of the print head 21 that is controlled by a microcontroller 38. The rejection of the additional print data signals may be effected by recognition of those signals by the microcontroller 38 or may be controlled by the microprocessor 11 of the postage meter.

If rejection of the print data signals is effected by recognition of those signals corresponding to the void mark 34, the print data signals on line 22 are input to the microcontroller 38 by line 39. The void mark 34 may have print location such that a portion of the void mark is located outside the area occupied by the printed postage indicium 35. For example an upper edge 40 of the void mark 34 may be located higher than the uppermost part 41 of the postage indicium. The difference in height between the edge 40 and the uppermost part 41 may be as little as one pixel or dot of the printed image. The microcontroller is arranged to inspect in each print data string a bit location corresponding to printing in a line one pixel above the part 41. In respect of print data strings corresponding to the postage indicium this bit position will be binary zero. However in respect of print data strings corresponding to the void marking this bit will be binary one. When binary one is detected in this bit position, the microcontroller operates the switch 37 to prevent transmission of any print data string corresponding to the void marking. Alternatively, only the first print data string corresponding to the void marking may have a binary one in the required bit position and the microcontroller may be operated to operate the switch for that string and a predetermined number of succeeding strings sufficient to prevent any print data string corresponding to the void marking being sent to the print head 21. In another alternative, the void marking is defined by predetermined print data strings and the microcontroller 38 is operated to count the print data strings and to operate the switch to reject those predetermined print data strings.

If it is desired to superimpose the void mark on the postage indicia, the microcontroller 38 may be controlled by control signals on line 42 from the microprocessor 11. Using this arrangement the microcontroller 38 could receive signals in respect of each bit of each successive string of print data signals which does not correspond to the postage indicium but does correspond to the void mark. Accordingly the switch 37 may be operated to reject each bit of the print data signals which is not required for printing the postage indicium. Alternatively the microcontroller 38 may include means to inhibit printing of the void mark. A bit map of the void print data may be stored in the module 20 and utilized by the microprocessor to control operation of the switch 37 to remove the void print data from the print data signals sent to the print head 21.

The switch 37 is shown for purposes of illustration as being connected between the print data signal line 22 and the print head however it is to be understood that other arrangements to reject the unwanted print data signals may be utilized. For example the switch may be connected in a return path of a driver circuit (not shown) of the print head 21. The switch may be an FET transistor.

I/we claim

1. A postage meter including first control means to generate print signals defining an invalid postage indicium, said print signals including first print data signals defining a valid postage indicium and second print data signals defining a void marking;
authorized printing means operative in response to said print data signals to print a postage indicium on a mail item; and
second control means operative to prevent operation of the authorized printing means by said second print data signals whereby the authorized printing means is operated by the first print data signals to print a valid postage indicium.

2. A postage meter as claimed in claim 1 wherein the print signals comprise a series of strings of print signals, first strings comprising first print data signals and second strings comprising second print data signals, a determined bit position of said strings of print data having a first binary value in respect of first print data signals and a second binary value in respect of second print data signals; and wherein the second control means is responsive to a binary value of said determined bit position to reject strings of print data in which the determined bit position has the second binary value.

3. A postage meter as claimed in claim 1 wherein the second control means is responsive to control signals generated by the first control means to reject print data signals defining the void marking and not defining the valid postage indicium.

4. A postage meter as claimed in claim 1 wherein the second control means stores a bit map of print data signals corresponding to the void marking and the second control means is operative to utilize said bit map to inhibit operation of the authorized printing means by print data signals defining the void marking.

5. A method of printing postage indicia including the steps of generating print data signals defining an invalid postage indicium; outputting said print data signals to authorised printing means; and rejecting selected ones of said print data signals to cause the authorised printing means to print a valid postage indicium.
